(19) United States
(12) Patent Application Publication
(10) Pub. No.: US 2025/0034423 A1
(43) Pub. Date: Jan. 30, 2025

(54) POLYURETHANE PRECURSOR-CONTAINING WOODY MATERIAL, POLYURETHANE-CONTAINING WOODY MATERIAL, POLYURETHANE-CONTAINGIN WOODY MOLDED ARTICLE, AND METHODS FOR MANUFACTURING SAME

(71) Applicant: NATIONAL INSTITUTE OF ADVANCED INDUSTRIAL SCIENCE AND TECHNOLOGY, Tokyo (JP)

(72) Inventors: Masako SEKI, Nagoya-shi (JP); Tsunehisa MIKI, Nagoya-shi (JP); Mitsuru ABE, Nagoya-shi (JP); Hiroshi ARAKI, Nagoya-shi (JP)

(73) Assignee: NATIONAL INSTITUTE OF ADVANCED INDUSTRIAL SCIENCE AND TECHNOLOGY, Tokyo (JP)

(21) Appl. No.: 18/717,313

(22) PCT Filed: Dec. 6, 2022
(86) PCT No.: PCT/JP2022/044923

§ 371 Date: Jun. 6, 2024

(30) Foreign Application Priority Data
Dec. 7, 2021 (JP) 2021-198847

(51) Int. Cl. C09D 15/00; B27N 3/00; C08F 290/06; C09D 151/08

(52) U.S. Cl. CPC C09D 15/00; B27N 3/002; C08F 290/062; C09D 151/08

(57) ABSTRACT

A polyurethane precursor-containing woody material that includes a woody raw material that is impregnated with a blocked isocyanate compound and a polyethylene glycol. The polyethylene glycol is represented by a formula: HO—(CH₂—CH₂—O), —H (n=1 to 12,000). The blocked isocyanate compound is a compound which is formed from an isocyanate compound and a blocking agent that protects an isocyanate group contained in the isocyanate compound, and is inactivated by a group derived from the blocking agent.

### TECHNICAL FIELD

The present invention relates to a polyurethane-containing woody molded article which has a soft feeling and thus is excellent in wood texture, a method for producing the same, a polyurethane precursor-containing woody material and a polyurethane-containing woody material used for producing the polyurethane-containing woody molded article, and methods for producing these.

### BACKGROUND ART

Conventionally, there has been known a technique of producing a woody molded article by forming a wood raw material, waste material, or recycled material, which are capable of reproducing, into powder, fiber, chip, or the like, then housing the wood raw material, waste material, or recycled material in a cavity of a mold together with a resin as necessary, and performing compression molding under a heating condition (see, Patent Literatures 1 and 2).

There is also known a technique of producing a woody molded article by subjecting an impregnated product obtained by impregnating a woody material with a component or resin having a functional group that reacts with hydroxy groups of wood to compression molding under a heating condition.

Non-Patent Literature 1 describes that a softwood material is impregnated with a water-soluble low-molecular-weight urethane resin, and then subjected to a deformation fixation treatment to prepare a compression-treated wood.

Non-Patent Literature 2 describes that wood is impregnated with a urethane prepolymer, and then heat-polymerization is performed to prepare polyurethane-impregnated wood, and that mechanical characteristics are improved by formation of the urethane resin film on the surface of the cell wall.

Non-Patent Literature 3 describes that when wood is immersed in an aqueous solution of polyethylene glycol (PEG), the cell wall swells due to water, and PEG molecules diffuse into the cell wall via water as a medium.

In addition, Non-Patent Literature 4 describes that a wood is impregnated with an isocyanate, and hydroxyl groups of the wood are reacted with the isocyanate to form a urethane bond, thereby performing dimensional stabilization treatment.

### PRIOR ART LITERATURE

### Patent Literature

Patent Literature 1: JP H11-300711 A

Patent Literature 2: JP 2010-155394 A

### Non-Patent Literature

Non-Patent Literature 1: Takumi Honda, Research Report of Yamanashi Forest Research Institute, No. 28, (2009) 23-28

Non-Patent Literature 2: Zhenhua Gao, et al., J. Applied Polymer Science, Vol. 111, (2009), 1293-1299

Non-Patent Literature 3: Yutaka Ishimaru, Wood Storage, 19 (5), (1993), 204-218

Non-Patent Literature 4: Masaharu Suzuki, et al., “Wood Science Series 8, Mokushitsu Shigen Zairyou (revised and extended)”, Kaiseisha Press, (1999), 35-38

### SUMMARY OF INVENTION

### Technical Problems

An object of the present invention is to provide a polyurethane-containing woody molded article which has a soft feeling and thus is excellent in wood texture and is capable of suppressing a dimensional change even when humidity conditions change, and a method for producing the same. Another object of the present invention is to provide a polyurethane precursor-containing woody material and a polyurethane-containing woody material suitable for producing such a molded article, and methods for producing these.

### Solutions to Problems

The present inventors have found that when a blocked isocyanate compound and polyethylene glycol are brought into contact with a woody material, a polyurethane precursor-containing woody material in which these compounds suitably permeate into cell walls is obtained, and thereafter, when the polyurethane precursor-containing woody material is heated, an isocyanate compound generated by decomposition of the blocked isocyanate compound reacts with the polyethylene glycol to form a polyurethane having two or more urethane bonds, and as a result, a polyurethane-containing woody molded article which has a soft feeling and thus is excellent in wood texture and is capable of suppressing a dimensional change even when humidity conditions change is obtained. Furthermore, the present inventors have found that the formed polyurethane can have thermoplastic properties, and in this case, the obtained woody molded article also has thermoplastic properties, and thus can be used for producing of woody molded articles having other shapes, that is, remolding can be performed.

The present invention is as follows.

[1] A polyurethane precursor-containing woody material characterized by comprising a woody raw material impregnated with a blocked isocyanate compound and a polyethylene glycol.

[2] The polyurethane precursor-containing woody material according to [1] above, wherein the polyethylene glycol is represented by a following general formula (1):

HO—(CH₂—CH₂—O)ₙ—H (1)
wherein n is 1 to 12,000.

[3] The polyurethane precursor-containing woody material according to [1] or [2] above, wherein the blocked isocyanate compound is a compound which is formed from an isocyanate compound and a blocking agent that protects an isocyanate group contained in the isocyanate compound, and is inactivated by a group derived from the blocking agent, and the blocked isocyanate compound is a compound which leads to the isocyanate compound when the blocked isocyanate compound is heated to dissociate the group derived from the blocking agent. [4] A method for producing the polyurethane precursor-containing woody material according to any one of [1] to [3] above, characterized by comprising a contact process in which the blocked isocyanate compound, the polyethylene glycol, and the woody raw material are brought into contact with each other.

[8 5] The method for producing a polyurethane precursor-containing woody material according to [4] above,
wherein the woody raw material is brought into contact with a liquid comprising the blocked isocyanate compound, the polyethylene glycol, and at least one selected from water and a water-soluble organic solvent in the contact process.

[6] A method for producing a polyurethane-containing woody material, characterized by heating the polyurethane precursor-containing woody material according to any one of [1] to [3] above, to a temperature at which an isocyanate compound is generated from a blocked isocyanate compound contained in the polyurethane precursor-containing woody material to form a polyurethane from the polyethylene glycol contained in the polyurethane precursor-containing woody material and the generated isocyanate compound.

[7] A polyurethane-containing woody material characterized by obtaining by the producing method according to [6] above.

[8] A polyurethane-containing woody material characterized by comprising a woody raw material impregnated with a polyurethane represented by a following formula.

R¹—NHCO—O—(CH₂—CH₂—O)ₙ—CONH—R²

(In the formula, R¹ and R² are each CH₂═C(CH₃)COOCH₂CH₂— and n is 1 to 12,000.) [9] A method for producing a polyurethane-containing woody molded article, characterized by comprising a heating process in which the polyurethane precursor-containing woody material according to any one of [1] to [3] above is heated to a temperature at which an isocyanate compound is generated from a blocked isocyanate compound contained in the polyurethane precursor-containing woody material to form a polyurethane from the polyethylene glycol contained in the polyurethane precursor-containing woody material and the generated isocyanate compound.

[10] The method for producing a polyurethane-containing woody molded article according to [9] above,
wherein pressurization is performed in the heating process.

A polyurethane-containing woody molded article characterized by obtaining by the producing method according to [9] or [10] above.

A polyurethane-containing woody molded article characterized by consisting of an aggregate of the polyurethane-containing woody material comprising a woody raw material impregnated with a polyurethane represented by a following formula.

R¹—NHCO—O—(CH₂—CH₂—O)ₙ-CONH-R²

(In the formula, R¹ and R² are each CH₂═C(CH₃)COOCH₂CH₂— and n is 1 to 12,000.)

### Advantageous Effects of Invention

According to the polyurethane precursor-containing woody material of the present invention, it is possible to produce a polyurethane-containing woody molded article which has a soft feeling and thus is excellent in wood texture and is capable of suppressing dimensional change even when humidity conditions change, for example, high humidity and low humidity are repeated.

According to the method for producing a polyurethane precursor-containing woody material of the present invention, a polyurethane precursor-containing woody material which exhibits the above effect can be efficiently produced.

According to the polyurethane-containing woody material of the present invention, it is possible to produce a polyurethane-containing woody molded article which has a soft feeling and thus is excellent in wood texture regardless of having a predetermined shape and is capable of suppressing dimensional change even when humidity conditions change, for example, high humidity and low humidity are repeated.

The polyurethane-containing woody material of the present invention can be easily produced only by heating a polyurethane precursor-containing woody material to a temperature at which an isocyanate compound is generated from a blocked isocyanate compound contained in the polyurethane precursor-containing woody material.

The polyurethane-containing woody molded article of the present invention can be easily produced only by heating a polyurethane precursor-containing woody material to a temperature at which an isocyanate compound is generated from a blocked isocyanate compound contained in the polyurethane precursor-containing woody material. In addition, the polyurethane-containing woody molded article of the present invention has a soft feeling and thus is excellent in wood texture, and the dimensional change thereof is suppressed even when humidity conditions change, for example, high humidity and low humidity are repeated. Furthermore, in the polyurethane-containing woody molded article of the present invention, the formed polyurethane can have thermoplastic properties, so that in this case, the obtained woody molded article also has thermoplastic properties. Therefore, when fine pieces and the like of such a woody molded article are used to perform remolding, other woody molded article can be easily produced.

### BRIEF DESCRIPTION OF DRAWINGS

FIG. 1 is a schematic view showing an example of a partial structure of a polyurethane precursor-containing woody material.

FIG. 2 shows infrared absorption spectra of woody molded articles obtained in Example 5, Comparative Example 2, and Comparative Example 3.

FIG. 3 is an external appearance image of a woody molded article obtained in Example 6 as viewed from obliquely above.

FIG. 4 is an external appearance image of a woody molded article obtained in Comparative Example 2 as viewed from obliquely above.

FIG. 5 is an external appearance image of a woody molded article obtained in Example 8 as viewed from directly above.

FIG. 6 is an external appearance image of a woody molded article obtained in Example 14 as viewed from directly above.

FIG. 7 is an external appearance image of a woody molded article obtained in Example 18 as viewed from directly above.

FIG. 8 is an external appearance image of a woody molded article obtained in Example 25 as viewed from directly above.

FIG. 9 is a graph showing the dimensional change rate in the T direction during a temperature and humidity cycling test of woody molded articles obtained in Examples 5 and 25 and Comparative Example 1.

FIG. 10 is a graph showing the dimensional change rate in the R direction during a temperature and humidity cycling test of woody molded articles obtained in Examples 5 and 25 and Comparative Example 1.

FIG. 11 shows ¹³C NMR spectra of woody molded articles obtained in Example 5 and Comparative Example 2.

FIG. 12 shows TG curves measured by thermogravimetry of woody molded articles obtained in Example 5, Comparative Example 1, and Comparative Example 2.

FIG. 13 is a graph showing the Brinell hardness of woody molded articles obtained in Examples 1 to 7 and Comparative Examples 1 to 2 and a Japanese cypress material (Comparative Example 4).

FIG. 14 is a perspective image showing a woody molded article having a small cup shape, obtained in Example 26.

FIG. 15 is an external appearance image of a woody molded article obtained in Example 27 as viewed from directly above.

### DESCRIPTION OF EMBODIMENT

The polyurethane precursor-containing woody material of the present invention is a material in which a woody raw material is impregnated with a blocked isocyanate compound and a polyethylene glycol and is a raw material for producing a polyurethane-containing woody material and a polyurethane-containing woody molded article. In the present invention, the expression “woody raw material is impregnated with a blocked isocyanate compound and a polyethylene glycol” includes not only the fact that the blocked isocyanate compound and polyethylene glycol permeate into the inside of the cell wall of the woody raw material, but also the fact that the blocked isocyanate compound and polyethylene glycol adhere to the cell surface and/or the external surface of the woody raw material.

The woody raw material is derived from a plant body having a cell wall, such as wood including softwood trees such as Japanese cedar, Japanese cypress, and pine, and hardwood trees such as poplar, beech, oak, and birch: bamboo: hemp plants such as jute, kenaf, flax, hemp, ramie, and sisal: and herbs. The woody raw material may be the plant body itself such as sawn boards, veneers, and sliced veneers; a waste material thereof; or a chemically treated product thereof. The shape and size of the woody raw material are not particularly limited.

The blocked isocyanate compound is preferably a compound which is formed from an isocyanate compound and a blocking agent that protects an isocyanate group contained in the isocyanate compound, and is inactivated by a group derived from the blocking agent. In the present invention, the blocked isocyanate compound is more preferably a compound which leads to the isocyanate compound when the blocked isocyanate compound is heated at a temperature ranging from 40° C. to 200° C. to deblock, that is, to dissociate the group derived from the blocking agent. A particularly preferable blocked isocyanate compound is a compound that forms a thermoplastic polyurethane through a reaction between the blocked isocyanate compound after deblocking and the ethylene glycol.

The isocyanate compound is not particularly limited as long as it has an isocyanate group, but the number of isocyanate groups contained is preferably in a range from 1 to 5, more preferably from 1 to 2, and particularly 1.

The isocyanate compound may have other functional groups such as a (meth)acryloyloxy group in addition to the isocyanate group.

Examples of the blocking agent include oximes such as formamidoxime, acetaldoxime, acetoxime, methyl ethyl ketoxime, diacetyl monoxime, benzophenone oxime, and cyclohexanone oxime: active methylenes such as dimethyl malonate, diethyl malonate, ethyl acetoacetate, methyl acetoacetate, and acetylacetone; lactams such as ε-caprolactam, δ-valerolactam, γ-butyrolactam, and β-propiolactam; phenols such as phenol, cresol, resorcinol, and xylenol; alcohols such as methanol, ethanol, n-propyl alcohol, isopropyl alcohol, n-butyl alcohol, isobutyl alcohol, sec-butyl alcohol, tert-butyl alcohol, ethylene glycol monoethyl ether, ethylene glycol monobutyl ether, diethylene glycol monoethyl ether, propylene glycol monomethyl ether, and benzyl alcohol; and the like.

The blocked isocyanate compound is particularly preferably a compound which has a structure of —N(H)CO before deblocking by heating, and in which a group derived from the blocking agent is bonded to the C atom in —N(H)CO. When the blocking agent is, for example, methyl ethyl ketoxime, the blocked isocyanate compound is a compound in which —O—N═C(CH₃)C₂H₅ obtained by eliminating an H atom from the methyl ethyl ketoxime is bonded to the C atom in —N(H)CO.

As described above, a blocked isocyanate compound having a (meth)acryloyloxy group is preferable as the blocked isocyanate compound which is deblocked to produce the isocyanate compound having other functional group such as a (meth)acryloy loxy group according to a preferred embodiment. When such a blocked isocyanate compound having a (meth)acryloyloxy group is used, a polyurethane-containing woody material and a polyurethane-containing woody molded article which have thermoplastic properties can be efficiently produced.

2-[0-(1′-methylpropylideneamino)carboxyamino] ethyl methacry late is particularly preferably as the blocked isocyanate compound, since this compound is a liquid at normal temperature, easily penetrates into the woody raw material, and can produce an isocyanate compound at a temperature of 200° C. or lower which does not occur to decompose the woody raw material.

The polyethylene glycol is preferably a compound represented by the following general formula (1).

HO—(CH₂—CH₂—O)ₙ—H (1)

In the general formula (1), n is preferably in a range from 1 to 12,000, more preferably from 4 to 500, and further preferably from 10 to 450 from a viewpoint of the permeability into the cell wall of the woody raw material.

In the polyurethane precursor-containing woody material of the present invention, a content ratio between the blocked isocyanate compound and the polyethylene glycol can be appropriately set according to the number of isocyanate groups contained in the isocyanate compound generated from the blocked isocyanate compound. In the present invention, content ratios of the blocked isocyanate compound and the polyethylene glycol are, respectively, preferably 5% to 95% by mass and 5% to 95% by mass, more preferably 20% to 80% by mass and 20% to 80% by mass, and further preferably 35% to 65% by mass and 35% to 65% by mass based on 100% by mass of a total of these.

In the polyurethane precursor-containing woody material for obtaining a woody molded article having good hygroscopicity and improved sensitive quality such as “moist feeling”, content ratios of the blocked isocyanate compound and the polyethylene glycol are, respectively, preferably 5% to 90% by mass and 10% to 95% by mass, more preferably 10% to 80% by mass and 20% to 90% by mass, and further preferably 20% to 50% by mass and 50% to 80% by mass.

In the polyurethane precursor-containing woody material for obtaining a woody molded article having improved dimensional stability in humidity change and durability such as heat resistance, content ratios of the blocked isocyanate compound and the polyethylene glycol are, respectively, preferably 5% to 95% by mass and 5% to 95% by mass, more preferably 10% to 95% by mass and 5% to 90% by mass, and further preferably 40% to 90% by mass and 10% to 60% by mass.

A total content ratio of the blocked isocyanate compound and the polyethylene glycol impregnated into the woody raw material is not particularly limited, and may depend on the type, site, shape, size, and the like of the woody raw material. The ratio is preferably in a range from 5 to 150 parts by mass, more preferably from 10 to 100 parts by mass, and further preferably from 20 to 50 parts by mass with respect to 100 parts by mass of the woody raw material.

A material impregnated into the woody raw material may be only the blocked isocyanate compound and polyethylene glycol, or other material may be further impregnated into the woody raw material. Examples of the other material include a liquid medium such as water and an organic solvent; and additives such as a thermosetting resin, an ultraviolet absorber, an antioxidant, a heat stabilizer, a light stabilizer, a plasticizer, an antiblocking agent, a release agent, a colorant, and a lubricant. A preferred embodiment of the present invention is one containing a liquid medium, and one further containing a thermosetting resin.

When the woody raw material is impregnated with a liquid medium, the solubility of the liquid medium in the blocked isocyanate compound and polyethylene glycol is not particularly limited. In a preferred embodiment of the present invention, the liquid medium preferably dissolves at least the blocked isocyanate compound. The medium that dissolves the blocked isocyanate compound is not particularly limited, but is usually an organic solvent. This organic solvent may be either an organic compound having polarity or a nonpolar organic compound. The organic solvent may be either water-soluble or water-insoluble. Specific examples of the organic solvent include an alcohol, a ketone such as acetone, an ether, a hydrocarbon such as hexane, and the like.

In the present invention, the organic solvent is preferably a water-soluble organic solvent. Examples of the water-soluble organic solvent include a monohydric alcohol, a polyhydric alcohol in which at least two hydrogen atoms constituting a hydrocarbon are all substituted with hydroxy groups, an alkyl ether of a dihydric alcohol, an aryl ether of a dihydric alcohol, and the like. The organic solvent may be composed of only one type or two or more types. The organic solvent is preferably a monohydric alcohol.

Examples of the monohydric alcohol include methanol, ethanol, 1-propanol, 2-propanol, 1-butanol, and the like.

Examples of the polyhydric alcohol include glycerin, 1,3-butanediol, 3-methyl-1,3-butanediol, 1,5-pentanediol, 1,6-hexanediol, ethylene glycol, triethylene glycol, tetraethylene glycol, propylene glycol, trimethylolethane, trimethylolpropane, 1,2,3-butanetriol, 1,2,4-butanetriol, 1,2,6-hexanetriol, and the like.

Examples of the alkyl ether of a dihydric alcohol include ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, propylene glycol monoethyl ether, and the like.

Examples of the aryl ether of a dihydric alcohol include ethylene glycol monophenyl ether, ethylene glycol monobenzyl ether, and the like.

The content ratios of the blocked isocyanate compound and the polyethylene glycol in the polyurethane precursor-containing woody material of the present invention are as described above.

When the polyurethane-containing woody material or the polyurethane-containing woody molded article is produced, the isocyanate compound generated from the blocked isocyanate compound reacts with the polyethylene glycol to form a polyurethane. Meanwhile, when the content ratio of the polyethylene glycol in terms of molar ratio of the hydroxy group and the isocyanate group is excessive, excessive polyethylene glycol that does not react with the isocyanate compound coexists with the polyurethane. When the polyurethane-containing woody material or the polyurethane-containing woody molded article contains polyethylene glycol not participating in a urethanization reaction, the remaining polyethylene glycol may be deliquesced under high humidity to cause stickiness on the surface of the polyurethane-containing woody material or the polyurethane-containing woody molded article. In such a case, when the thermosetting resin is used in combination, the deliquescence of polyethylene glycol can be suppressed.

In the present invention, when the thermosetting resin is contained as an additive in the polyurethane precursor-containing woody material, the heat resistance, water resistance, and the like of the polyurethane-containing woody molded article obtained using the polyurethane precursor-containing woody material can be improved. The content ratio of the thermosetting resin in the polyurethane precursor-containing woody material is not particularly limited, but is preferably 0.1 to 2 times, more preferably 0.2 to 1.5 times the total amount of the blocked isocyanate compound and polyethylene glycol. When the polyurethane formed from the polyethylene glycol and isocyanate compound generated from the blocked isocyanate compound is thermoplastic, the thermoplastic properties of the obtained polyurethane-containing woody material or polyurethane-containing woody molded article can be maintained even when the thermosetting resin is contained at the above content ratio.

Examples of the thermosetting resin include a phenol resin, an epoxy resin, a melamine resin, a urea resin, an unsaturated polyester resin, an alkyd resin, a thermosetting polyurethane resin, a thermosetting polyimide resin, and the like. When the polyurethane precursor-containing woody material contains a thermosetting resin, a crosslinking agent may also be contained. As the crosslinking agent, a crosslinking agent corresponding to the type of the blocked isocyanate compound and polyethylene glycol can be used without any particular limitation.

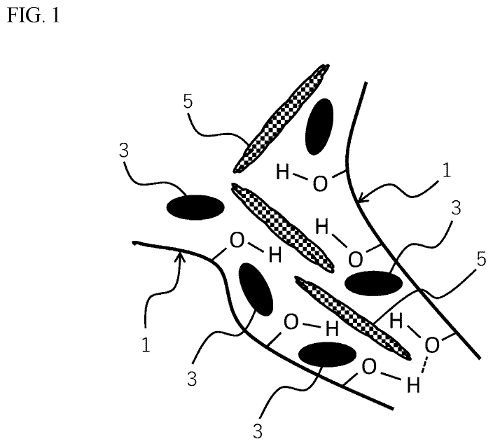

FIG. 1 is an example of a partial structure of the polyurethane precursor-containing woody material of the present invention, and shows a state in which a blocked isocyanate compound 3 and polyethylene glycol 5 are contained in the cell wall of the woody raw material.

The polyurethane precursor-containing woody material of the present invention can be produced by a method including a contact process in which the blocked isocyanate compound, the polyethylene glycol, and the woody raw material are brought into contact with each other.

In the contact process, the above-described other materials such as a liquid medium and additives can be used in combination, in addition to the blocked isocyanate compound, polyethylene glycol, and woody raw material. In the present invention, from a viewpoint of the smooth impregnation property of the blocked isocyanate compound and polyethylene glycol, it is preferable that other materials contain a liquid medium. The liquid medium preferably contains at least one selected from water and a water-soluble organic solvent, and particularly preferably contains both water and a water-soluble organic solvent. The water-soluble organic solvent is preferably a monohydric alcohol, and one or two or more of the compounds exemplified above can be used. When the liquid medium is composed of the monohydric alcohol and water, the upper limit of the content of the monohydric alcohol is preferably 60% by mass, and more preferably 40% by mass. When the liquid medium contains water, the cell wall of the woody raw material tends to swell, so that the efficiency of impregnation of the materials into the woody raw material is improved.

In the contact process, a method of using the materials is exemplified below:
(A) a method of bringing a mixture composed of a blocked isocyanate compound, a polyethylene glycol, and other materials such as a liquid medium and additives to be used in combination as necessary into contact with a woody raw material:
(B) a method of bringing a first raw material composed of a blocked isocyanate compound and other materials such as a liquid medium and additives to be used in combination as necessary into contact with a woody raw material, and then bringing a second raw material composed of a polyethylene glycol and other materials such as a liquid medium and additives to be used in combination as necessary and/or a blocked isocyanate compound into contact with the woody raw material; and
(C) a method of bringing a first raw material composed of a polyethylene glycol and other materials such as a liquid medium and additives to be used in combination as necessary into contact with a woody raw material, and then bringing a second raw material composed of a blocked isocyanate compound and other materials such as a liquid medium and additives to be used in combination as necessary and/or a polyethylene glycol into contact with the woody raw material.

Among these methods, the method (A) in which a liquid medium is used in combination is preferable.

In the methods (A), (B) and (C), when a liquid medium is used, the pure content concentration (total concentration) of the blocked isocyanate compound and/or polyethylene glycol is preferably in a range from 1% to 70% by mass, and more preferably from 5% to 30% by mass from a viewpoint of the impregnation property into the woody raw material. The usage ratios of the blocked isocyanate compound and polyethylene glycol to be used are, respectively, preferably 5% to 95% by mass and 5% to 95% by mass, more preferably 20% to 80% by mass and 20% to 80% by mass, and further preferably 35% to 65% by mass and 35% to 65% by mass based on 100% by mass of a total of both.

The woody raw material used in the methods (A), (B) and (C) may be dried or may be impregnated with only a liquid medium in advance.

In order to sufficiently impregnate the woody raw material with the material in the methods (A), (B), and (C), a method of placing (immersing) the woody raw material in the material, a method of performing only once or repeating at least one of depressurization and pressurization in a state where the woody raw material is in contact with the material in a sealable container, a method of applying the material to the woody raw material, and the like can be applied.

In the contact process, contact conditions of the woody raw material and the blocked isocyanate compound and polyethylene glycol are appropriately selected depending on the type, site, shape, and size of the woody raw material, but are generally as follows. The contact temperature is preferably in a range from 5° C. to 40° C., and more preferably from 10° C. to 35° C. The contact time (total) is preferably in a range from 10 minutes to 72 hours, and more preferably from 1 to 48 hours.

In the method for producing a polyurethane precursor-containing woody material of the present invention, when the liquid medium is used in combination in the contact process, the production method may include, after the contact process, a drying process in which the woody raw material to which the material has been attached is dried, in order to remove a part or all of the liquid medium. The temperature of the drying process is not particularly limited, but it is preferable to perform natural drying, air drying, or the like under the condition of a temperature at which no isocyanate compound is generated from the blocked isocyanate compound, preferably 40° C. or lower.

According to the method for producing a polyurethane precursor-containing woody material of the present invention, a polyurethane precursor-containing woody material can be obtained in which the total amount of the blocked isocyanate compound and polyethylene glycol is preferably in a range from 5 to 150 parts by mass, more preferably from 10 to 100 parts by mass, and further preferably from 20 to 50 parts by mass based on 100 parts by mass of a dried woody raw material.

The polyurethane-containing woody material of the present invention is a material having a predetermined shape or an indefinite shape obtained by the method for producing a polyurethane-containing woody material of the present invention, the method including heating the polyurethane precursor-containing woody material to a temperature at which an isocyanate compound is generated from a blocked isocyanate compound contained in the polyurethane precursor-containing woody material to form a polyurethane from the polyethylene glycol contained in the polyurethane precursor-containing woody material and the generated isocyanate compound.

In addition, the polyurethane-containing woody molded article of the present invention is a molded article having a predetermined shape obtained by the method for producing a polyurethane-containing woody molded article of the present invention, the method including a heating step of heating the polyurethane precursor-containing woody material to a temperature at which an isocyanate compound is generated from a blocked isocyanate compound contained in the polyurethane precursor-containing woody material to form a polyurethane from the polyethylene glycol contained in the polyurethane precursor-containing woody material and the generated isocyanate compound.

In the method for producing a polyurethane-containing woody material of the present invention and the method for producing a polyurethane-containing woody molded article of the present invention, the heating temperature of the polyurethane precursor-containing woody material is selected depending on the type of the blocked isocyanate compound to be contained. The heating temperature is preferably in a range from 40° C. to 200° C., and more preferably from 80° C. to 180° C. since the blocked isocyanate compound is efficiently subjected to deblocking to generate the isocyanate compound, and the generated isocyanate compound reacts with the polyethylene glycol contained in the polyurethane precursor-containing woody material to smoothly form a polyurethane.

In the present invention, both of the polyurethane-containing woody material and the polyurethane-containing woody molded article preferably contain a polyurethane formed from the polyethylene glycol contained in the polyurethane precursor-containing woody material and an isocyanate compound generated from a blocked isocyanate compound. Polyethylene glycol may be further contained depending on the constitution of the polyurethane precursor-containing woody material.

Accordingly, the polyurethane-containing woody material of the present invention has a main body part derived from the woody raw material and a polyurethane filling part formed by filling the inside of the woody raw material with the polyurethane in a state where the shape and size of the woody raw material are substantially maintained, and optionally has a polyurethane film part in which a film made of the polyurethane is formed on at least a part of the surface of the woody raw material.

The polyurethane-containing woody molded article of the present invention is (i) a woody molded article having a main body part derived from the woody raw material having a predetermined shape and a polyurethane filling part formed by filling the inside of the woody raw material with the polyurethane, and optionally having a polyurethane film part in which a film made of the polyurethane is formed on at least a part of the surface of the woody raw material, or (ii) a woody molded article formed of an aggregate of polyurethane-containing woody materials formed by subjecting a plurality of polyurethane-containing woody materials composed of small pieces and the like to heat pressing or the like. In these embodiments, a soft feeling is imparted due to a polyurethane having a structure including an oxyethylene group derived from polyethylene glycol to thereby enhance wood texture, and dimensional change is suppressed even when humidity conditions change, and thus an excellent shape retention property is obtained.

Here, the polyurethane of a particularly preferred embodiment in the polyurethane-containing woody material of the present invention and the polyurethane-containing woody molded article of the present invention will be described. When the blocked isocyanate compound contained in the polyurethane precursor-containing woody material is a compound which has one group —N(H)CO and in which a group derived from the blocking agent is bonded to the C atom of the group —N(H)CO, an isocyanate compound generated by heating the polyurethane precursor-containing woody material has one isocyanate group. Therefore, two moles of the isocyanate compound react with one mole of the polyethylene glycol to form a polyurethane represented by the following general formula (2).

R¹—NHCO—O—(CH₂—CH₂—O)ₙ—CONH—R² (2)

(In the formula, R¹ and R² are each an organic group, and n is 1 to 12,000.)

In the general formula (2), R¹ and R² are identical or different organic groups, and when the blocked isocyanate compound contained in the polyurethane precursor-containing woody material is, for example, 2-[0-(1′-methylpropylideneamino)carboxyamino]ethyl methacrylate, a polyurethane (hereinafter, referred to as “polyurethane (U)”) in which R¹ and R² are each CH₂═C(CH₃)COOCH₂CH₂— is formed.

Since the blocked isocyanate compound and polyethylene glycol contained in the polyurethane precursor-containing woody material are present in the cell lumen and the cell wall of the woody raw material, the polyurethane formed by heating the polyurethane precursor-containing woody material to a temperature at which an isocyanate compound is generated from the blocked isocyanate compound is also present in the cell lumen and the cell wall of the woody raw material.

Furthermore, FIG. 1 showing a polyurethane precursor-containing woody material before heating depicts a wood polymer 1 in the cell wall. Since the wood polymer 1 usually has a hydroxy group, it is considered that this hydroxy group reacts with the isocyanate compound generated from the blocked isocyanate compound by heating to form a urethane bond-containing polymer derived from the woody raw material. Therefore, in the above embodiment, the polyurethane-containing woody material and the polyurethane-containing woody molded article contain a polyurethane formed from the polyethylene glycol and the isocyanate compound generated from a blocked isocyanate compound, and a urethane bond-containing polymer derived from a woody raw material, which is formed by a reaction between the wood polymer 1 and the isocyanate compound as described above. In a case where the former polyurethane is represented by the general formula (2), a woody molded article containing this polyurethane is excellent in soft feeling, hardly deformed, and further excellent in shape retention property when placed in an atmosphere where humidity conditions change.

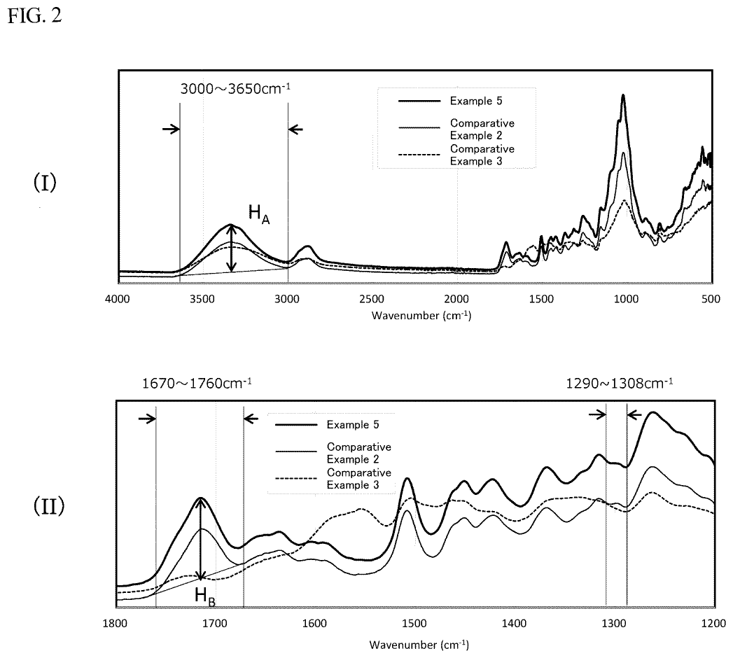

From the infrared absorption spectrum or ¹³C NMR spectrum of the polyurethane-containing woody material and the polyurethane-containing woody molded article of the present invention, it is clear that a polyurethane is formed by a reaction of the generated isocyanate compound and the polyethylene glycol. For example, according to solid NMR measurement (¹³C PST-MAS NMR), a peak derived from an oxyethylene group can be confirmed at a chemical shift of around 73 ppm in the NMR spectrum. According to FT-IR measurement (ATR method), absorption peaks can be confirmed at a wavenumber ranging from 3,000 to 3,650 cm⁻¹ (O—H, C═O, —CONH—) and a wavenumber ranging from 1,670 to 1,760 cm⁻¹ (C═O) of the infrared absorption spectrum (see the absorption curve of Example 5 in FIG. 2). In the present invention, when the height of the absorption peak at a wavenumber ranging from 3,000 to 3,650 cm⁻¹ (O—H, C—O, —CONH—) is defined as H^{A} and the height of the absorption peak at a wavenumber ranging from 1,670 to 1,760 cm⁻¹ (C═O) is defined as H^{B}, the H^{B}/H^{A} ratio is preferably 0.2 or more, and more preferably 0.4 or more from viewpoints of dimensional stability and heat resistance of the obtained woody molded article. In addition, the absorption peak or the inflection point of C—N can be confirmed at a wavenumber ranging from 1,290 to 1,308 cm⁻¹ of the infrared absorption spectrum.

As described above, the polyurethane-containing woody molded article of the present invention may be of (i) an embodiment in which the size of a woody raw material having a predetermined shape is reflected, or (ii) an embodiment in which the polyurethane-containing woody molded article is an aggregate of polyurethane-containing woody materials composed of small pieces and the like. In the embodiment (ii), since the formed polyurethane acts as an adhesive by heating, for example, when pressing under pressure or the like is utilized, the retention property of a desired shape is high.

When the Brinell hardness of the polyurethane-containing woody molded article of the present invention is measured by the method described in Examples below, the Brinell hardness is preferably in a range from 0.01 to 5 N/mm²(=MPa), and more preferably from 0.1 to 2 N/mm² although it depends on the type, position to be cut out, density of wood, and the like.

The polyurethane-containing woody molded article of the present invention can be used in various environments, and for example, even when humidity conditions change, for example, high humidity and low humidity are repeated, the dimensional change thereof can be suppressed.

As described above, the method for producing a polyurethane-containing woody molded article of the present invention is a method including a heating step of heating the polyurethane precursor-containing woody material to a temperature at which an isocyanate compound is generated from a blocked isocyanate compound contained in the polyurethane precursor-containing woody material to form a polyurethane from the polyethylene glycol contained in the polyurethane precursor-containing woody material and the generated isocyanate compound. The heating temperature in this heating step is as described above.

In the method for producing a polyurethane-containing woody molded article of the present invention, a method of performing a heating step while pressurizing can be applied depending on the shape and size of the polyurethane precursor-containing woody material as a raw material for producing. A preferred production method is a pressure molding method using a mold.

In the method for producing a polyurethane-containing woody molded article of the present invention, when the shape and size of the polyurethane precursor-containing woody material are the same as those of the polyurethane-containing woody molded article to be obtained, a method of performing only the heating step can be applied.

In the method for producing a polyurethane-containing woody molded article of the present invention, when the polyurethane precursor-containing woody material contains a blocked isocyanate compound and polyethylene glycol which form a thermoplastic polyurethane, and further contains a thermosetting resin as an additive, the deformation resistance required for consolidation of woody cells during molding can be increased by preheating the polyurethane precursor-containing woody material before producing of the molded article, and then subjecting the preheated material to a molding step. Then, a polyurethane-containing woody molded article can be produced while maintaining voids therein. In such a polyurethane-containing woody molded article, woody texture (appearance, softness) depending on voids derived from original wood is further improved.

In the method for producing a polyurethane-containing woody molded article of the present invention, a polyurethane precursor-containing woody material obtained by impregnating a woody raw material with a blocked isocyanate compound and a polyethylene glycol is used as a raw material for producing. It is therefore possible to produce a polyurethane-containing woody molded article which has a soft feeling and thus is excellent in wood texture and whose increase in dimensional change rate is suppressed even when humidity conditions change as described above. When a polyurethane precursor-containing woody material is prepared by impregnating a woody raw material with a urethane prepolymer, the inside of the cell wall of the woody raw material is not sufficiently impregnated with the urethane prepolymer. Accordingly, the present invention is a technique that cannot be realized by a polyurethane precursor-containing woody material using such a urethane prepolymer.

The polyurethane-containing woody material and the polyurethane-containing woody molded article of the present invention can also be produced by heating a polyurethane precursor-containing woody material obtained by impregnating a woody raw material with at least a blocked isocyanate compound, a polyethylene glycol, and a liquid medium to a temperature equal to or higher than a temperature at which an isocyanate compound is generated from the blocked isocyanate compound. In this case, the removal of the liquid medium and the production of polyurethane can proceed substantially simultaneously, which is also preferable from viewpoints of energy efficiency and production time.

Another embodiment of the polyurethane-containing woody material of the present invention is a polyurethane-containing woody material obtained by impregnating a woody raw material with the polyurethane (U).

Another embodiment of the polyurethane-containing woody molded article of the present invention is a polyurethane-containing woody molded article composed of an aggregate of polyurethane-containing woody materials obtained by impregnating a woody raw material with the polyurethane (U).

In the present invention, the expression “the woody raw material is impregnated with the polyurethane (U)” includes not only the fact that the polyurethane (U) permeates into the inside of the cell wall of the woody raw material, but also the fact that the polyurethane (U) adheres to the cell surface and/or the external surface of the woody raw material.

When the polyurethane to be formed is thermoplastic, the polyurethane-containing woody molded article of the present invention can also be produced by a method in which the polyurethane-containing woody material and/or the polyurethane-containing woody molded article or a crushed product thereof is pressurized while being heated.

### EXAMPLES

Hereinafter, the present invention is specifically described by way of Examples. The present invention is not limited to the Examples. The units “%” and “part(s)” in the following description are based on weight unless otherwise indicated.

### 1. Raw Materials for Producing Polyurethane Precursor-Containing Woody Material

### 1-1. Woody Material

### (1) Woody raw Material A

An end grain surface sample of Japanese cypress having a size of 20 mm (radial direction: R)×20 mm (tangential direction: T)×5 mm (fiber direction: L) and a rotary-sliced veneer sample of Japanese cypress (45 mm×45 mm) having a thickness (R) of about 1 mm each after drying at a temperature of 105° C. for 1 hour or longer were used.

### (2) Woody raw Material B

An end grain surface sample of Japanese cedar having a size of 24 mm (radial direction: R)×33 mm (tangential direction: T)×4 mm (fiber direction: L) and a rotary-sliced veneer sample (48 mm×48 mm) of Japanese cedar having a thickness (R) of about 1 mm each after drying at a temperature of 105° C. for 1 hour or longer were used.

### (3) Woody raw Material C

A rotary-sliced veneer sample (48 mm×48 mm) of Japanese cypress having a thickness (R) of about 4 mm after drying at a temperature of 105° C. for 1 hour or longer was used.

### 1-2. Blocked Isocyanate Compound (MOI)

2-[0-(1′-methylpropylideneamino)carboxyamino]ethyl methacrylate “Karenz MOI-BM” (product name) manufactured by Resonac Holdings Corporation was used.

This compound is a compound which is deblocked by being heated at about 120° C. or higher, that is, the compound is a compound in which a methyl ethyl ketoxime group is dissociated by this heating.

### 1-3. Polyethylene Glycol

### (1) Polyethylene Glycol 600 (PEG 600)

Polyethylene glycol “PEG-600” (product name) manufactured by FUJIFILM Wako Pure Chemical Corporation was used. The average molecular weight is 560 to 640.

### (2) Polyethylene Glycol 1540 (PEG1540)

Polyethylene glycol “polyethylene glycol 1,540” (product name) manufactured by FUJIFILM Wako Pure Chemical Corporation was used. The molecular weight is about 1,500.

### (3) Polyethylene Glycol 4000 (PEG4000)

Polyethylene glycol “polyethylene glycol 4,000” (product name) manufactured by FUJIFILM Wako Pure Chemical Corporation was used. The average molecular weight is 2,700 to 3,300.

### (4) Polyethylene Glycol 6000 (PEG6000)

Polyethylene glycol “polyethylene glycol-6000” (product name) manufactured by FUJIFILM Wako Pure Chemical Corporation was used. The average molecular weight is 7,300 to 9,300.

### (5) Polyethylene Glycol 20000 (PEG 20000)

Polyethylene glycol “polyethylene glycol 20,000” (product name) manufactured by FUJIFILM Wako Pure Chemical Corporation was used. The average molecular weight is 15,000 to 25,000.

### 1-4. Melamine Resin (Additive)

Melamine/formaldehyde-based resin “AMIDIR M-3 (60)” (product name) manufactured by DIC CORPORATION was used. It is a water-soluble resin.

### 2. Production and Evaluation of Polyurethane Precursor-Containing Woody Material and Polyurethane-Containing Woody Molded Article

Various impregnation liquids were prepared by the following preparation methods using the above raw materials and water or ethanol. Next, the woody raw material was impregnated with the impregnation liquid to produce a polyurethane precursor-containing woody material. Thereafter, a plate-like polyurethane-containing woody molded article was produced using this polyurethane precursor-containing woody material.

### <Impregnation Liquid Preparation Method>

### (1) Preparation Method W1

A preparation method of mixing a polyethylene glycol aqueous solution obtained by dissolving polyethylene glycol previously melted at 60° C. in water with a blocked isocyanate compound.

### (2) Preparation Method W2

A preparation method of mixing polyethylene glycol previously melted at 60° C. with an ethanol solution obtained by dissolving a blocked isocyanate compound in ethanol.

(3) Preparation M ethod W3

A preparation method of mixing a polyethylene glycol aqueous solution obtained by dissolving polyethylene glycol previously melted at 60° C. in water with an ethanol solution obtained by dissolving a blocked isocyanate compound in ethanol, and adding water thereto as necessary.

### (4) Preparation Method W4

A preparation method of dissolving polyethylene glycol previously melted at 60° C. in water to prepare a polyethylene glycol aqueous solution, cooling the polyethylene glycol aqueous solution to room temperature, then adding a melamine resin to the cooled aqueous solution to prepare a mixed liquid, mixing the mixed liquid with an ethanol solution obtained by dissolving a blocked isocyanate compound in ethanol, and adding water thereto as necessary.

### Example 1

The preparation method W1 was applied to obtain an aqueous solution (hereinafter, referred to as “impregnation liquid L1”) having a mass ratio of polyethylene glycol 1540 (PEG1540) to blocked isocyanate compound (MOI) of 1:2 and a solid content concentration of 20%.

Subsequently, the woody raw material A was immersed in the impregnation liquid L1 at a temperature of about 20° C., in this state, depressurization (0.01 MPa, 1 hour) was performed at room temperature (about 20° C.), and then pressurization (0.8 MPa, about 18 hours) was performed. The woody raw material to which the material had been attached was taken out from the impregnation liquid L1, placed on a net shelf, air-dried at room temperature (about 20° C.) for 2 days, and then dried in a blower dryer at 35° C. for about 3 days and further in a vacuum dryer at 35° C. for 2 days or longer, thereby obtaining a polyurethane precursor-containing woody material as a product from which the solvent had been removed.

The weight increase rate and the dimension increase rate of the obtained polyurethane precursor-containing woody material (impregnated wood) with respect to the woody raw material A before being brought into contact with the impregnation liquid L1 were measured or calculated (see Table 1). The dimension increase rate was calculated based on the dimension in the T direction in the end grain surface sample.

Five polyurethane precursor-containing woody materials obtained by impregnating a veneer sample of the woody raw material A with the impregnation liquid L1 were placed in a closed mold having a flat plate with a punch area of 52 mm×50 mm set at a temperature of 160° C., press-molded with a load of 5 ton (about 19 MPa), and a plate-like woody molded article having a thickness of about 1.5 mm was taken out without cooling the mold. This woody molded article was then cut, and an infrared absorption spectrum (ATR) of a cross section thereof was measured. The measuring device was an infrared spectrophotometer “NICOLET 6700 FT-IR” (model name) manufactured by Thermo Fisher Scientific Inc., and diamond was used as a prism. The measurement wavenumber region was 4,000 to 500 cm⁻¹. From the obtained infrared absorption spectrum, the ratio (H^{B}/H^{A} ratio) between the height (H^{A}) of the absorption peak at 3,000 to 3,650 cm⁻¹ (O—H, C—O, —CONH—) and the height (H^{B}) of the absorption peak at 1,670 to 1,760 cm⁻¹ (C═O) was calculated (see Table 1 and FIG. 2).

### Example 2

The preparation method W2 was applied to obtain an ethanol solution (hereinafter, referred to as “impregnation liquid L2”) having a mass ratio of polyethylene glycol 1540 (PEG1540) to blocked isocyanate compound (MOI) of 1:1 and a solid content concentration of 20%.

After that, the same operations as in Example 1 were performed except that the impregnation liquid L2 was used instead of the impregnation liquid L1 to produce a polyurethane precursor-containing woody material and a plate-like woody molded article. The weight increase rate, the dimension increase rate, and the H^{B}/H^{A} ratio based on the infrared absorption spectrum were then obtained (see Table 1).

### Example 3

The preparation method W2 was applied to obtain an ethanol solution (hereinafter, referred to as “impregnation liquid L3”) having a mass ratio of polyethylene glycol 1540 (PEG1540) to blocked isocyanate compound (MOI) of 2:1 and a solid content concentration of 20%.

After that, the same operations as in Example 1 were performed except that the impregnation liquid L3 was used instead of the impregnation liquid L1 to produce a polyurethane precursor-containing woody material and a plate-like woody molded article. The weight increase rate, the dimension increase rate, and the H^{B}/H^{A} ratio based on the infrared absorption spectrum were then obtained (see Table 1).

### Example 4

The preparation method W2 was applied to obtain an ethanol solution (hereinafter, referred to as “impregnation liquid L4”) having a mass ratio of polyethylene glycol 1540 (PEG1540) to blocked isocyanate compound (MOI) of 4:1 and a solid content concentration of 20%.

After that, the same operations as in Example 1 were performed except that the impregnation liquid L4 was used instead of the impregnation liquid L1 to produce a polyurethane precursor-containing woody material and a plate-like woody molded article. The weight increase rate, the dimension increase rate, and the H^{B}/H^{A} ratio based on the infrared absorption spectrum were then obtained (see Table 1).

### Example 5

The preparation method W3 was applied to obtain an impregnation liquid (hereinafter, referred to as “impregnation liquid L5”) containing a 35% ethanol aqueous solution, and having a mass ratio of polyethylene glycol 1540 (PEG1540) to blocked isocyanate compound (MOI) of 1:2, and a solid content concentration of 20%.

After that, the same operations as in Example 1 were performed except that the impregnation liquid L5 was used instead of the impregnation liquid L1 to produce a polyurethane precursor-containing woody material and a plate-like woody molded article. The weight increase rate, the dimension increase rate, and the H^{B}/H^{A} ratio based on the infrared absorption spectrum were then obtained (see Table 1).

### Example 6

The preparation method W3 was applied to obtain an impregnation liquid (hereinafter, referred to as “impregnation liquid L6”) containing a 35% ethanol aqueous solution, and having a mass ratio of polyethylene glycol 1540 (PEG1540) to blocked isocyanate compound (MOI) of 1:1.5, and a solid content concentration of 20%.

After that, the same operations as in Example 1 were performed except that the impregnation liquid L6 was used instead of the impregnation liquid L1 to produce a polyurethane precursor-containing woody material and a plate-like woody molded article. The weight increase rate, the dimension increase rate, and the H^{B}/H^{A} ratio based on the infrared absorption spectrum were then obtained (see Table 1).

### Example 7

The preparation method W3 was applied to obtain an impregnation liquid (hereinafter, referred to as “impregnation liquid L7”) containing a 35% ethanol aqueous solution, and having a mass ratio of polyethylene glycol 1540 (PEG1540) to blocked isocyanate compound (MOI) of 1:1, and a solid content concentration of 20%.

After that, the same operations as in Example 1 were performed except that the impregnation liquid L7 was used instead of the impregnation liquid L1 to produce a polyurethane precursor-containing woody material and a plate-like woody molded article. The weight increase rate, the dimension increase rate, and the H^{B}/H^{A} ratio based on the infrared absorption spectrum were then obtained (see Table 1).

### Comparative Example 1

Polyethylene glycol 1540 (PEG1540) was dissolved in ethanol to obtain an ethanol solution (hereinafter, referred to as “impregnation liquid LL1”) having a polyethylene glycol 1540 concentration of 20%.

After that, the same operations as in Example 1 were performed except that the impregnation liquid LL1 was used instead of the impregnation liquid L1 to produce a polyurethane precursor-containing woody material and a plate-like woody molded article. The weight increase rate and the dimension increase rate were then obtained (see Table 1).

### Comparative Example 2

The blocked isocyanate compound (MOI) was dissolved in ethanol to obtain an ethanol solution (hereinafter, referred to as “impregnation liquid LL2”) having a blocked isocyanate compound concentration of 20%.

After that, the same operations as in Example 1 were performed except that the impregnation liquid LL2 was used instead of the impregnation liquid L1 to produce a polyurethane precursor-containing woody material and a plate-like woody molded article. The weight increase rate, the dimension increase rate, and the H^{B}/H^{A} ratio based on the infrared absorption spectrum were then obtained (see Table 1).

### Comparative Example 3

The same operations as in Example 1 were performed except that a melamine/formaldehyde-based resin “AMIDIR M-3” (product name) manufactured by DIC Corporation was used instead of the impregnation liquid L1, and a melamine resin aqueous solution (hereinafter, referred to as “impregnation liquid LL3”) having a solid content concentration of the melamine/formaldehyde-based resin of 10% was used to produce a polyurethane precursor-containing woody material and a plate-like woody molded article. The weight increase rate, the dimension increase rate, and the H^{B}/H^{A} ratio based on the infrared absorption spectrum were then obtained (see Table 1).

### Example 8

The preparation method W3 was applied to obtain an impregnation liquid (hereinafter, referred to as “impregnation liquid L8”) containing a 20% ethanol aqueous solution, and having a mass ratio of polyethylene glycol 600 (PEG600) to blocked isocyanate compound (MOI) of 4:1, and a solid content concentration of 20%.

Subsequently, the woody raw material B was immersed in the impregnation liquid L8 at a temperature of about 20° C., in this state, depressurization (0.01 MPa, 1 hour) was performed at room temperature (about 20° C.), and then pressurization (0.8 MPa, about 18 hours) was performed. The woody raw material to which the material had been attached was taken out from the impregnation liquid L8, placed on a net shelf, air-dried at room temperature (about 20° C.) for 7 days, and then dried in a blower dryer at 35° C. for about 3 days and further in a vacuum dryer at 35° C. for 2 days or longer, thereby obtaining a polyurethane precursor-containing woody material as a product from which the solvent had been removed.

The weight increase rate and the dimension increase rate of the obtained polyurethane precursor-containing woody material (impregnated wood) with respect to the woody raw material B before being brought into contact with the impregnation liquid L8 were measured or calculated (see Table 2). The dimension increase rate was calculated based on the dimension in the T direction in the end grain surface sample. Further, an end grain surface sample of the polyurethane precursor-containing woody material was cut in the fiber direction, and the infrared absorption spectrum (ATR) of the cross section (flat grain surface) was measured in the same manner as in Example 1 to calculate the H_{B}/H_{A} ratio (see Table 2 and FIG. 2).

Ten polyurethane precursor-containing woody materials obtained by impregnating a veneer sample of the woody raw material B with the impregnation liquid L8 were placed in a closed mold having a flat plate with a punch area of 52 mm×50 mm set at a temperature of 160° C., press-molded with a load of 5 ton (about 19 MPa), and the mold was cooled to 40° C. or lower, then a plate-like woody molded article having a thickness of 2.8 mm was taken out.

### Example 9

The preparation method W3 was applied to obtain an impregnation liquid (hereinafter, referred to as “impregnation liquid L9”) containing a 20% ethanol aqueous solution, and having a mass ratio of polyethylene glycol 1540 (PEG1540) to blocked isocyanate compound (MOI) of 4:1, and a solid content concentration of 20%.

After that, the same operations as in Example 8 were performed except that the impregnation liquid L9 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 10

The preparation method W3 was applied to obtain an impregnation liquid (hereinafter, referred to as “impregnation liquid L10”) containing a 20% ethanol aqueous solution, and having a mass ratio of polyethylene glycol 4000 (PEG4000) to blocked isocyanate compound (MOI) of 4:1, and a solid content concentration of 20%.

After that, the same operations as in Example 8 were performed except that the impregnation liquid L10 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 11

The preparation method W3 was applied to obtain an impregnation liquid (hereinafter, referred to as “impregnation liquid L11”) containing a 25% ethanol aqueous solution, and having a mass ratio of polyethylene glycol 600 (PEG600) to blocked isocyanate compound (MOI) of 2:1, and a solid content concentration of 20%.

After that, the same operations as in Example 8 were performed except that the impregnation liquid L11 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 12

The preparation method W3 was applied to obtain an impregnation liquid (hereinafter, referred to as “impregnation liquid L12”) containing a 25% ethanol aqueous solution, and having a mass ratio of polyethylene glycol 1540 (PEG1540) to blocked isocyanate compound (MOI) of 2:1, and a solid content concentration of 20%.

After that, the same operations as in Example 8 were performed except that the impregnation liquid L12 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 13

The preparation method W3 was applied to obtain an impregnation liquid (hereinafter, referred to as “impregnation liquid L13”) containing a 25% ethanol aqueous solution, and having a mass ratio of polyethylene glycol 4000 (PEG4000) to blocked isocyanate compound (MOI) of 2:1, and a solid content concentration of 20%.

After that, the same operations as in Example 8 were performed except that the impregnation liquid L13 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 14

The preparation method W3 was applied to obtain an impregnation liquid (hereinafter, referred to as “impregnation liquid L14”) containing a 35% ethanol aqueous solution, and having a mass ratio of polyethylene glycol 600 (PEG600) to blocked isocyanate compound (MOI) of 1:1, and a solid content concentration of 20%.

After that, the same operations as in Example 8 were performed except that the impregnation liquid L14 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 15

The preparation method W3 was applied to obtain an impregnation liquid (hereinafter, referred to as “impregnation liquid L15”) containing a 35% ethanol aqueous solution, and having a mass ratio of polyethylene glycol 1540 (PEG1540) to blocked isocyanate compound (MOI) of 1:1, and a solid content concentration of 20%.

After that, the same operations as in Example 8 were performed except that the impregnation liquid L15 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 16

The preparation method W3 was applied to obtain an impregnation liquid (hereinafter, referred to as “impregnation liquid L16”) containing a 35% ethanol aqueous solution, and having a mass ratio of polyethylene glycol 4000 (PEG4000) to blocked isocyanate compound (MOI) of 1:1, and a solid content concentration of 20%.

After that, the same operations as in Example 8 were performed except that the impregnation liquid L16 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 17

The preparation method W3 was applied to obtain an impregnation liquid (hereinafter, referred to as “impregnation liquid L17”) containing a 35% ethanol aqueous solution, and having a mass ratio of polyethylene glycol 6000 (PEG6000) to blocked isocyanate compound (MOI) of 1:1, and a solid content concentration of 20%.

After that, the same operations as in Example 8 were performed except that the impregnation liquid L17 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 18

The preparation method W3 was applied to obtain an impregnation liquid (hereinafter, referred to as “impregnation liquid L18”) containing a 35% ethanol aqueous solution, and having a mass ratio of polyethylene glycol 20000 (PEG20000) to blocked isocyanate compound (MOI) of 1:1, and a solid content concentration of 20%.

After that, the same operations as in Example 8 were performed except that the impregnation liquid L18 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 19

The preparation method W3 was applied to obtain an impregnation liquid (hereinafter, referred to as “impregnation liquid L19”) containing a 35% ethanol aqueous solution, and having a mass ratio of polyethylene glycol 600 (PEG600) to blocked isocyanate compound (MOI) of 1:2, and a solid content concentration of 20%.

After that, the same operations as in Example 8 were performed except that the impregnation liquid L19 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 20

The preparation method W3 was applied to obtain an impregnation liquid (hereinafter, referred to as “impregnation liquid L20”) containing a 35% ethanol aqueous solution, and having a mass ratio of polyethylene glycol 1540 (PEG1540) to blocked isocyanate compound (MOI) of 1:2, and a solid content concentration of 20%.

After that, the same operations as in Example 8 were performed except that the impregnation liquid L20 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 21

The preparation method W3 was applied to obtain an impregnation liquid (hereinafter, referred to as “impregnation liquid L21”) containing a 35% ethanol aqueous solution, and having a mass ratio of polyethylene glycol 4000 (PEG4000) to blocked isocyanate compound (MOI) of 1:2, and a solid content concentration of 20%.

After that, the same operations as in Example 8 were performed except that the impregnation liquid L21 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 22

The preparation method W3 was applied to obtain an impregnation liquid (hereinafter, referred to as “impregnation liquid L22”) containing a 40% ethanol aqueous solution, and having a mass ratio of polyethylene glycol 600 (PEG600) to blocked isocyanate compound (MOI) of 1:4, and a solid content concentration of 20%.

After that, the same operations as in Example 8 were performed except that the impregnation liquid L22 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 23

The preparation method W3 was applied to obtain an impregnation liquid (hereinafter, referred to as “impregnation liquid L23”) containing a 40% ethanol aqueous solution, and having a mass ratio of polyethylene glycol 1540 (PEG1540) to blocked isocyanate compound (MOI) of 1:4, and a solid content concentration of 20%.

After that, the same operations as in Example 8 were performed except that the impregnation liquid L23 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 24

The preparation method W3 was applied to obtain an impregnation liquid (hereinafter, referred to as “impregnation liquid L24”) containing a 40% ethanol aqueous solution, and having a mass ratio of polyethylene glycol 4000 (PEG4000) to blocked isocyanate compound (MOI) of 1:4, and a solid content concentration of 20%.

After that, the same operations as in Example 8 were performed except that the impregnation liquid L24 was used instead of the impregnation liquid L8 to produce a polyurethane precursor-containing woody material and a plate-like woody molded article. The weight increase rate, the dimension increase rate, and the H^{B}/H^{A} ratio based on the infrared absorption spectrum were then obtained (see Table 2).

### Example 25

The preparation method W4 was applied to obtain an impregnation liquid (hereinafter, referred to as “impregnation liquid L25”) containing a 35% ethanol aqueous solution, and having a mass ratio of polyethylene glycol 1540 (PEG1540), blocked isocyanate compound (MOI), and melamine resin of 1:1:1, and a solid content concentration of 20%.

Subsequently, the woody raw material C was immersed in the impregnation liquid L25 at a temperature of about 20° C., in this state, depressurization (0.01 MPa, 2 hours) was performed at room temperature (about 20° C.), and then pressurization (0.8 MPa, about 20 hours) was performed. The woody raw material to which the material had been attached was taken out from the impregnation liquid L25, placed on a net shelf, air-dried at room temperature (about 20° C.) for 4 days, and then dried in a blower dryer at 35° C. for about 2 days and further in a vacuum dryer at 35° C. for 6 days or longer, thereby obtaining a polyurethane precursor-containing woody material as a product from which the solvent had been removed.

The weight increase rate of the obtained polyurethane precursor-containing woody material (impregnated wood) with respect to the woody raw material C before being brought into contact with the impregnation liquid L25 was calculated (see Table 3).

Three polyurethane precursor-containing woody materials obtained by impregnating a veneer sample of the woody raw material C with the impregnation liquid L25 were placed in a closed mold having a flat plate with a punch area of 52 mm×50 mm set at a temperature of 170° C. press-molded with a load of 10 ton (about 38 MPa), and the mold was cooled to 50° C. or lower. then a plate-like woody molded article having a thickness of 4.0 mm was taken out.

TABLE 1

| | | | | | | | Impregnated wood | | | | |
|---|---|---|---|---|---|---|---|---|---|---|---|
| | Impregnation liquid | | | | | | | | | Dimension | |
| | | | | | | Solid | | Weight increase | | increase | Woody |
| | | | | | PEG:MOI | content | Woody | rate (%) | | rate in T | molded |
| | | Preparation | | Main | (mass | concen- | raw | (End | | direction | article |
| | Type | method | Medium | component | ratio) | tration (%) | material | grain) | (Veneer) | (%) | H_{B}/H_{A} |
| Example 1 | L1 | W1 | Water | PEG1540, MOI | 1:2 | 20 | A | 50 | 72 | 2.4 | 0.70 |
| Example 2 | L2 | W2 | Ethanol | PEG1540, MOI | 1:1 | 20 | A | 23 | 32 | 1.3 | 0.45 |
| Example 3 | L3 | W2 | Ethanol | PEG1540, MOI | 2:1 | 20 | A | 22 | 32 | 1.4 | 0.25 |
| Example 4 | L4 | W2 | Ethanol | PEG1540, MOI | 4:1 | 20 | A | 23 | 31 | 1.4 | 0.21 |
| Example 5 | L5 | W3 | Ethanol | PEG1540, MOI | 1:2 | 20 | A | 45 | 39 | 2.5 | 0.50 |
| | | | 35% aqueous | | | | | | | | |
| | | | solution | | | | | | | | |
| Example 6 | L6 | W3 | Ethanol | PEG1540, MOI | 1:1.5 | 20 | A | 45 | 38 | 2.6 | 0.55 |
| | | | 35% aqueous | | | | | | | | |
| | | | solution | | | | | | | | |
| Example 7 | L7 | W3 | Ethanol | PEG1540, MOI | 1:1 | 20 | A | 44 | 38 | 2.6 | 0.42 |
| | | | 35% aqueous | | | | | | | | |
| | | | solution | | | | | | | | |
| Comparative | LL1 | — | Ethanol | PEG1540 | — | 20 | A | 26 | 32 | 1.4 | Unmea- |
| Example 1 | | | | | | | | | | | sured |
| Comparative | LL2 | — | Ethanol | MOI | — | 20 | A | 23 | 31 | 0.9 | 0.56 |
| Example 2 | | | | | | | | | | | |
| Comparative | LL3 | — | Water | Melamine | — | 10 | A | 29 | 25 | 1.5 | 0.14 |
| Example 3 | | | | resin | | | | | | | |

TABLE 2

| | | | | | | | Impregnated wood | | | | |
|---|---|---|---|---|---|---|---|---|---|---|---|
| | Impregnation liquid | | | | | | | | | Dimension | |
| | | | | | | Solid | | Weight increase | | increase | Woody |
| | | | | | PEG MOI | content | Woody | rate (%) | | rate in T | molded |
| | | Preparation | | Main | (mass | concen- | raw | (End | | direction | article |
| | Type | method | Medium | component | ratio) | tration (%) | material | grain) | (Veneer) | (%) | H_{B}/H_{A} |
| Example 8 | L8 | W3 | Ethanol | PEG600, MOI | 4:1 | 20 | B | 60 | 66 | 9.4 | 0.69 |
| | | | 20% aqueous | | | | | | | | |
| | | | solution | | | | | | | | |
| Example 9 | L9 | W3 | Ethanol | PEG1540, MOI | 4:1 | 20 | B | 59 | 67 | 9.0 | 0.85 |
| | | | 20% aqueous | | | | | | | | |
| | | | solution | | | | | | | | |
| Example 10 | L10 | W3 | Ethanol | PEG4000, MOI | 4:1 | 20 | B | 60 | 69 | 8.6 | 0.97 |
| | | | 20% aqueous | | | | | | | | |
| | | | solution | | | | | | | | |
| Example 11 | L11 | W3 | Ethanol | PEG600, MOI | 2:1 | 20 | B | 60 | 69 | 9.3 | 1.03 |
| | | | 25% aqueous | | | | | | | | |
| | | | solution | | | | | | | | |
| Example 12 | L12 | W3 | Ethanol | PEG1540, MOI | 2:1 | 20 | B | 60 | 71 | 9.0 | 1.42 |
| | | | 25% aqueous | | | | | | | | |
| | | | solution | | | | | | | | |
| Example 13 | L13 | W3 | Ethanol | PEG4000, MOI | 2:1 | 20 | B | 60 | 64 | 8.9 | 1.50 |
| | | | 25% aqueous | | | | | | | | |
| | | | solution | | | | | | | | |
| Example 14 | L14 | W3 | Ethanol | PEG600, MOI | 1:1 | 20 | B | 58 | 58 | 9.0 | 1.37 |
| | | | 35% aqueous | | | | | | | | |
| | | | solution | | | | | | | | |
| Example 15 | L15 | W3 | Ethanol | PEG1540, MOI | 1:1 | 20 | B | 57 | 66 | 9.0 | 1.88 |
| | | | 35% aqueous | | | | | | | | |
| | | | solution | | | | | | | | |
| Example 16 | L16 | W3 | Ethanol | PEG4000, MOI | 1:1 | 20 | B | 58 | 58 | 9.0 | 1.95 |
| | | | 35% aqueous | | | | | | | | |
| | | | solution | | | | | | | | |

TABLE 3

| | | | | | | | Impregnated wood | | | | |
|---|---|---|---|---|---|---|---|---|---|---|---|
| | Impregnation liquid | | | | | | | | | Dimension | |
| | | | | | | Solid | | Weight increase | | increase | Woody |
| | | | | | PEG:MOI | content | Woody | rate (%) | | rate in T | molded |
| | | Preparation | | Main | (mass | concen- | raw | (End | | direction | article |
| | Type | method | Medium | component | ratio) | tration (%) | material | grain) | (Veneer) | (%) | H_{B}/H_{A} |
| Example 17 | L17 | W3 | Ethanol | PEG6000, MOI | 1:1 | 20 | B | 58 | 70 | 8.7 | 2.66 |
| | | | 35% aqueous | | | | | | | | |
| | | | solution | | | | | | | | |
| Example 18 | L18 | W3 | Ethanol | PEG20000, MOI | 1:1 | 20 | B | 58 | 62 | 8.5 | 2.20 |
| | | | 35% aqueous | | | | | | | | |
| | | | solution | | | | | | | | |
| Example 19 | L19 | W3 | Ethanol | PEG600, MOI | 1:2 | 20 | B | 57 | 58 | 7.9 | 1.64 |
| | | | 35% aqueous | | | | | | | | |
| | | | solution | | | | | | | | |
| Example 20 | L20 | W3 | Ethanol | PEG1540, MOI | 1:2 | 20 | B | 57 | 58 | 8.8 | 1.81 |
| | | | 35% aqueous | | | | | | | | |
| | | | solution | | | | | | | | |
| Example 21 | L21 | W3 | Ethanol | PEG4000, MOI | 1:2 | 20 | B | 57 | 67 | 8.7 | 2.21 |
| | | | 35% aqueous | | | | | | | | |
| | | | solution | | | | | | | | |
| Example 22 | L22 | W3 | Ethanol | PEG600, MOI | 1:4 | 20 | B | 55 | 57 | 8.5 | 1.88 |
| | | | 40% aqueous | | | | | | | | |
| | | | solution | | | | | | | | |
| Example 23 | L23 | W3 | Ethanol | PEG1540, MOI | 1:4 | 20 | B | 55 | 63 | 8.2 | 1.83 |
| | | | 40% aqueous | | | | | | | | |
| | | | solution | | | | | | | | |
| Example 24 | L24 | W3 | Ethanol | PEG4000, MOI | 1:4 | 20 | B | 55 | 63 | 8.2 | 1.94 |
| | | | 40% aqueous | | | | | | | | |
| | | | solution | | | | | | | | |
| Example 25 | L25 | W4 | Ethanol | PEG1540, MOI | *1 | 20 | C | Unused | 43 | Unmea- | Unmea- |
| | | | 35% aqueous | Melamine | | | | | | sured | sured |
| | | | solution | resin | | | | | | | |

*1 PEG:MOI:melamine resin = 1:1:1.

The following can be seen from Table 1. In Examples 1 and 5 to 7 in which the medium of the impregnation liquid was water or an ethanol aqueous solution, that is, a medium containing water was used, the dimension increase rate in the T direction in the impregnated wood was also higher than those of Examples 2 to 4 and Comparative Examples 1 and 2 in which the medium was only ethanol, and therefore the permeability into the inside of the cell wall was good. From this result, it can be seen that when the impregnation liquid in which the medium is water or an ethanol aqueous solution is used, the retention property of the impregnation liquid is excellent particularly in the cell wall of the woody raw material (raw material wood).

In addition, the following can be seen from Tables 2 and 3. In Examples 8 to 24 in which the medium was an ethanol aqueous solution, the dimensional increase rate in the T direction in the obtained impregnated wood was also higher than those of Examples 2 to 4 and Comparative Examples 1 and 2 in which the medium was only ethanol, and therefore the permeability into the inside of the cell wall was good. Thus, when an impregnation liquid containing polyethylene glycol having a molecular weight of about 550 to 20,000, that is, polyethylene glycol in which n is 12 to 454 in the general formula: HO—(CH₂—CH₂—O)ₙ—H, a blocked isocyanate compound (MOI), and an ethanol aqueous solution was used, the permeability into the inside of the cell wall was good.

Furthermore, it was confirmed that when polyethylene glycol and a blocked isocyanate compound (MOI) were used at a mass ratio of from 4:1 to 1:4, the permeability into the inside of the cell wall was good.

In Examples 1, 2 and 5 to 24, the HB/HA ratio calculated from the infrared absorption spectrum of the obtained woody molded article was 0.50 or more. In Examples 1 to 24, the absorption peak or the inflection point of C—N was confirmed in the wavenumber range of from 1,290 to 1,308 cm⁻¹ in the infrared absorption spectrum.

Here, FIG. 2 shows infrared absorption spectra of the woody molded articles obtained in Example 5, Comparative Example 2, and Comparative Example 3. (I) is an infrared absorption spectrum in a wide wavenumber range (4,000 to 500 cm⁻¹), and (II) is an infrared absorption spectrum in an enlarged wavenumber range (1,800 to 1,200 cm⁻¹) of the spectrum of (I). In Example 5 and Comparative Example 2, the absorption peak or the inflection point of C—N was confirmed in the wavenumber range of from 1,290 to 1,308 cm⁻¹ in the infrared absorption spectra.

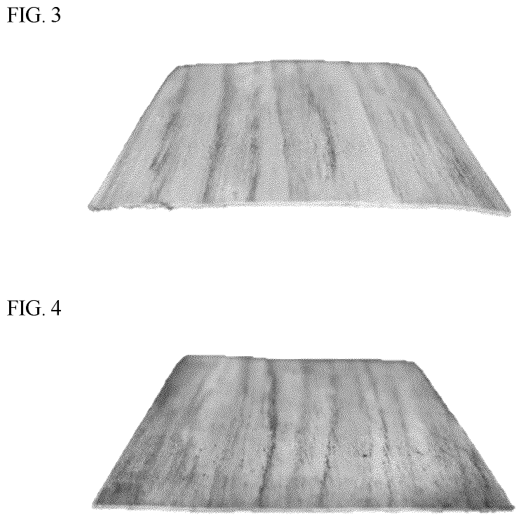

Next, a polyurethane precursor-containing woody material obtained by impregnating a veneer sample (one sheet) with each impregnation liquid prepared in Examples 1 to 7 and Comparative Examples 1 to 3 was placed in a closed mold having a flat plate with a punch area of 52 mm×50 mm set at a temperature of 160° C., press-molded at a load of 5 ton (about 19 MPa) for 5 minutes, and a plate-like woody molded article was taken out from the mold without cooling. The obtained woody molded articles were visually observed, and it was found that the woody molded articles obtained in Examples 1 to 7 had a wood texture more than the woody molded articles obtained in Comparative Examples 1 to 3. FIGS. 3 and 4 show images obtained by photographing the woody molded article obtained in Example 6 and the woody molded article obtained in Comparative Example 2 with a digital camera, respectively.

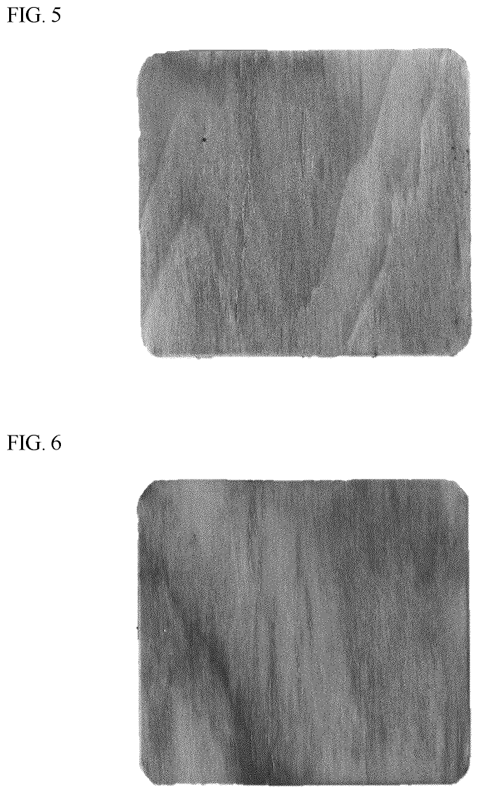

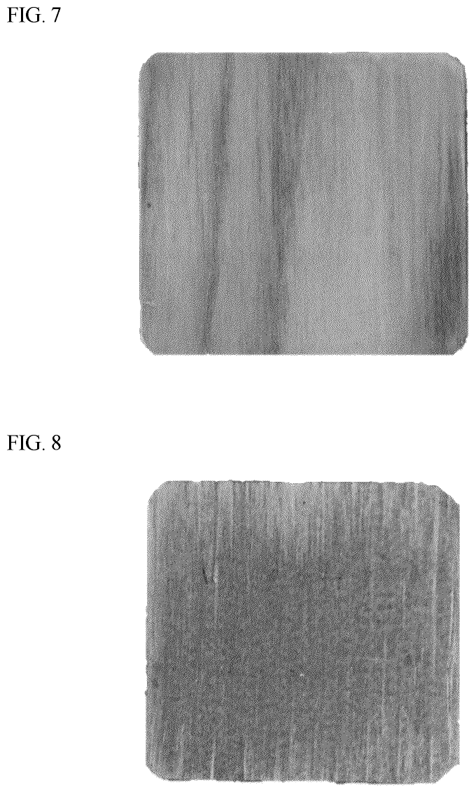

Furthermore, the woody molded articles obtained in Examples 8 to 25 were visually observed, and it was found that these woody molded articles had a wood texture more than the woody molded articles of Comparative Examples 1 to 3. FIGS. 5, 6, 7 and 8 show the appearance images of the woody molded articles obtained in Examples 8, 14, 18 and 25, respectively.

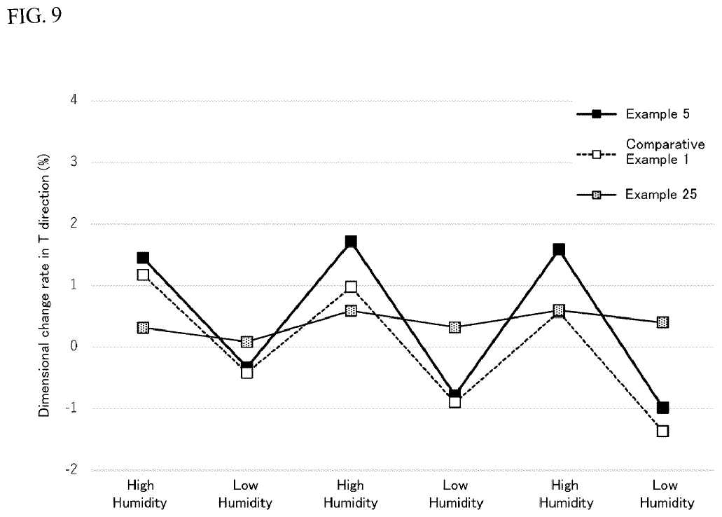

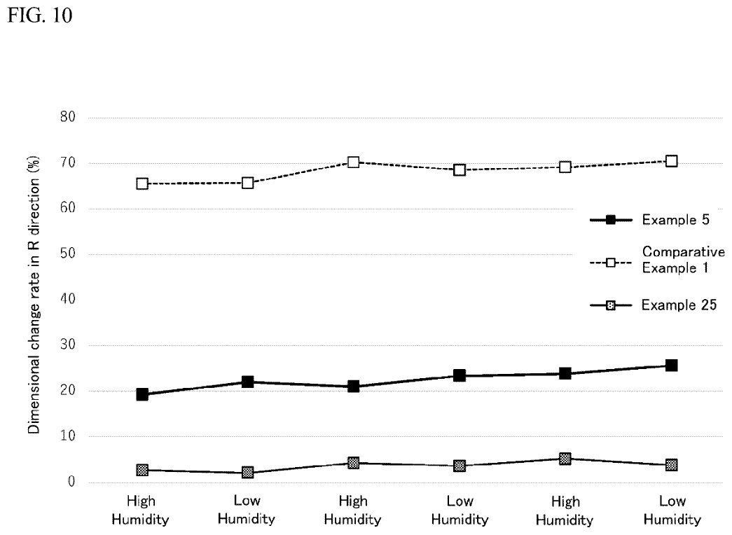

In addition, the condition of each of the plate-like woody molded articles obtained in Example 5 and Comparative Example 1 was adjusted in an environment of a temperature of 20° C. and a relative humidity of 60% over 7 days or longer. Then, the adjustment in a high humidity environment of a temperature of 30° C. and a relative humidity of 90% and the adjustment in a low humidity environment of a temperature of 30° C. and a relative humidity of 12% were alternately repeated for 24 hours each. The dimension change rates in the T direction (molded article width direction) and the R direction (molded article thickness direction) at that time were measured. These results are shown in FIGS. 9 and 10, respectively.

As shown in FIG. 9, the fluctuation range of the dimension change rate in the T direction was slightly smaller in Comparative Example 1 than in Example 5. However, in Comparative Example 1, the dimension in the R direction (thickness direction of the molded article) shown in FIG. 10 was changed by 60% or more under the first high humidity condition, whereas in Example 5, the dimension change rate was smaller than Comparative Example 1, resulting in excellent dimensional stability.

Three polyurethane precursor-containing woody materials obtained using the veneer samples obtained in Example 5 and Comparative Example 1 were subjected to heat-press molding in the same manner as described above to obtain plate-like woody molded articles. The condition of each of these woody molded articles was adjusted in an environment at a temperature of 20° C. and a relative humidity of 60% over 7 days or longer. Then, the adjustment in a high humidity environment at a temperature of 30° C. and a relative humidity of 90% and the adjustment in a low humidity environment at a temperature of 30° C. and a relative humidity of 12% were repeated for 24 hours each. As a result, the plate-like woody molded article of Comparative Example I was delaminated and decomposed in the second cycle of moisture absorption and drying. On the other hand, in the plate-like woody molded article of Example 5, such a defect was not found.

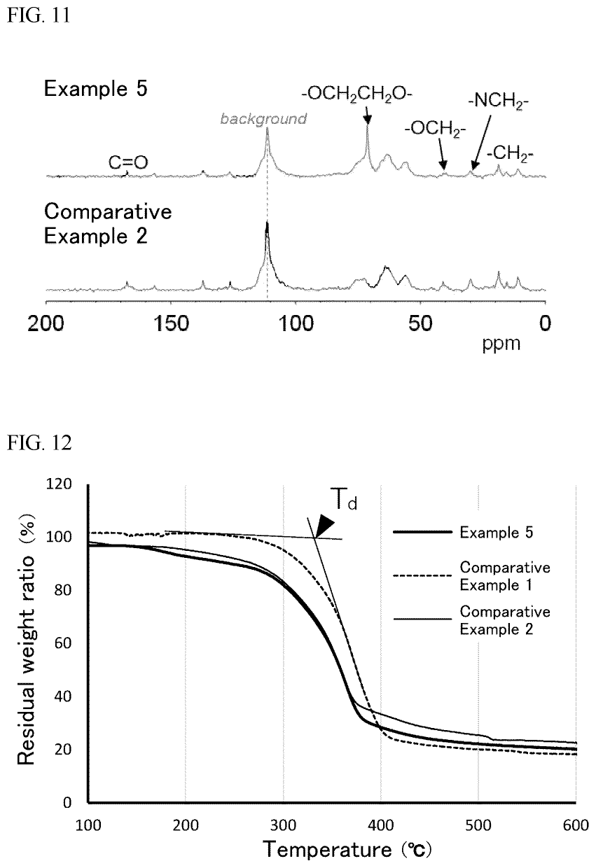

Furthermore, each of the plate-like woody molded articles obtained in Example 5 and Comparative Example 2 was made into powder, and the powder was subjected to solid NMR measurement (¹³C PST-MAS NMR). FIG. 11 shows the obtained NMR spectra, and in the case of the woody molded article of Example 5, a peak derived from an oxyethylene group (—CH₂—CH₂—O—) constituting polyurethane formed from polyethylene glycol 1540 (PEG1540) and a blocked isocyanate compound (MOI) could be confirmed at 73 ppm.

Subsequently, each of the plate-like woody molded articles obtained in Example 5, Comparative Example 1, and Comparative Example 2 was subjected to thermogravimetry (TG) under the condition where the temperature was raised from room temperature to 600° C. at 10° C./min in a nitrogen atmosphere. FIG. 12 show obtained TG curves, and each TG curve showed a behavior that the weight sharply decreases between 250° C. and 400° C. Then, for example, as shown for the curve of Comparative Example 1 in FIG. 12, when the temperature at the intersection point of a line extrapolated from a flat region from 100° C. to 200° C. and a line extrapolated from a region from 250° C. to 400° C. where the weight sharply decreases was defined as the thermal decomposition start temperature “Td”, Td of Comparative Example 1 was 300° C. or higher, and Td of Example 5 and Comparative Example 2 was 300° C. or higher.

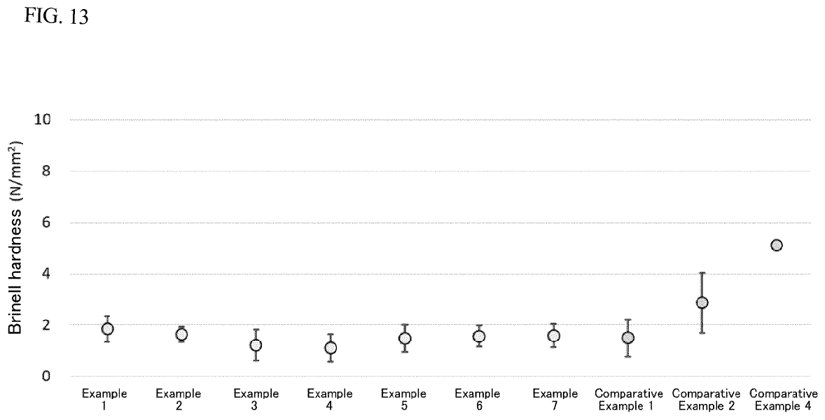

In addition, the condition of each of the woody molded articles obtained in Examples 2 to 7and Comparative Examples 1 to 3 was adjusted over 7 days or more under an environment of a temperature of 20° C. and a relative humidity of 60%. Then, the Brinell hardness was measured using a compact tabletop tester “EZ-TEST EZ-S” (model name) manufactured by Shimadzu Corporation. As Comparative Example 4, the Brinell hardness was measured only for a Japanese cypress veneer (thickness: 4 mm). It is to be noted that this measurement was performed at seven points in each molded article. FIG. 13 is a graph showing the Brinell hardness of each woody molded article, and it can be seen that the woody molded articles of Examples 1 to 7 have a Brinell hardness lower than those of Comparative Examples 2 and 3 and thus have softness. Here, the woody molded article obtained in Comparative Example 3 has too high hardness to measure the Brinell hardness, and no data is shown in FIG. 13. In addition, the woody molded articles obtained in Examples 1 to 7 had a value of Brinell hardness lower than that of the Japanese cypress veneer of Comparative Example 4, and was softer than the wood material.

Next, the performance of the woody molded article obtained in Example 25 using a melamine resin in combination as an additive will be described.

The condition of the plate-like woody molded article obtained in Example 25 was adjusted in an environment of a temperature of 20° C. and a relative humidity of 60% over 7 days or more. Then, the adjustment in a high humidity environment of a temperature of 30° C. and a relative humidity of 90% and the adjustment in a low humidity environment of a temperature of 30° C. and a relative humidity of 12% were alternately repeated for 24 hours each. The dimension change rates in the T direction (molded article width direction) and the R direction (molded article thickness direction) at that time were measured. These results are shown in FIGS. 9 and 10 in comparison with Examples 5 and Comparative Example 1, respectively.

In both the T direction (FIG. 9) and the R direction (FIG. 10), the dimensional change rate and the fluctuation range thereof in Example 25 were smaller than those in Example 5 and Comparative Example 1. From this, it was found that the dimensional stability of the obtained woody molded article can be significantly improved by using a thermosetting resin such as a melamine resin as an additive.

One surface of one polyurethane precursor-containing woody material obtained by impregnating a veneer sample with the impregnation liquid L25 obtained in Example 25 was brought into contact with a hot plate set at a temperature of 170° C. for 5 minutes to preheat the polyurethane precursor-containing woody material. Thereafter, this preheated material and other two polyurethane precursor-containing woody materials that had not been preheated were stacked, and this was placed in a closed mold (170° C.) having a flat plate with a punch area of 52 mm×50 mm. That is, three polyurethane precursor-containing woody materials were placed in a mold. At this time, the other two polyurethane precursor-containing woody materials were stacked so as not to come into contact with the surface (preheating surface) of the preheated material, which had been brought into contact with the hot plate. Next, a load was applied to the stack to press-mold the stack, and the mold was cooled to 50° C. or lower, and then a woody molded article (preheated molded article) was prepared. Two types of woody molded articles (preheated molded articles) were obtained by setting the load for press molding to 1.3 ton (about 5 MPa) and 2.5 ton (about 9.5 MPa).

The thicknesses of the woody molded article (hereinafter, referred to as “preheated molded article P1”) obtained with a load of about 5 MPa and the woody molded article (hereinafter, referred to as “preheated molded article P2”) obtained with a load of about 9.5 MPa were 5.4 mm and 3.9mm, respectively, and the densities were 1.2 g/cm³ and 0.9 g/cm³, respectively. From this, it was found that the density of the preheated molded article P1 was smaller than that of the preheated molded article P2, and the woody molded article was not completely consolidated, that is, voids in the molded article were maintained.

Subsequently, the Brinell hardness was measured for both surfaces of each of the preheated molded articles P1 and P2 using a compact tabletop tester “EZ-TEST EZ-S” (model name) manufactured by Shimadzu Corporation. As a result, it was found that the Brinell hardness of the preheated surface derived from the preheated polyurethane precursor-containing woody material in the preheated molded article P1 was about 9 N/mm², which was lower than about 35 N/mm² of the surface derived from the unpreheated polyurethane precursor-containing woody material, and thus the preheated surface had softness. On the other hand, the Brinell hardness of the preheated surface derived from the preheated polyurethane precursor-containing woody material in the preheated molded article P2 was about 45 N/mm², which was slightly higher than about 41 N/mm² of the surface derived from the unpreheated polyurethane precursor-containing woody material. From the above, with regard to the softness by preheating, it is preferable that molding is performed at a pressure that does not block voids in wood (that is, a pressure required for consolidation).

### 3. Other Production Examples of Polyurethane-Containing Woody Molded Article

### Example 26

As described below, a polyurethane precursor-containing woody material was subjected to press molding using a mold including an upper mold (punch) and a lower mold which provide a cavity having a small cup shape, thereby producing a woody molded article having the small cup shape (hereinafter, referred to as “first molded article”). The first molded article was then pulverized, and the pulverized product was subjected to the same press molding again, thereby producing a woody molded article having the same small cup shape (hereinafter, referred to as “second molded article”).

A Japanese cypress veneer having a thickness of 4 mm (R) was immersed in the impregnation liquid L1 prepared in Example 1, and in this state, depressurization (0.01 MPa, 1 hour) was performed at room temperature (about 20° C.), and then pressurization (0.8 MPa, about 18 hours) was performed. Then, the Japanese cypress veneer was taken out from the impregnation liquid L1,placed on a net shelf, air-dried at room temperature (about 20° C.) for 2 days, and then dried in a blower dryer at 35° C. for about 3 days and further in a vacuum dryer at 35° C. for 2 days or more to remove the solvent, thereby obtaining a polyurethane precursor-containing woody material.

Subsequently, the polyurethane precursor-containing woody material was cut into a disc shape (hereinafter, referred to as “pre-molding material”) having a diameter of about 45 mm, then a plurality of the pre-molding materials were stacked, and this stack was subjected to press molding. That is, a mold (lower mold) for providing a cavity having a small cup shape with an opening diameter of 50 mm was heated to 140° C. in advance, 58 g of the plurality of pre-molding materials was placed in the mold, an upper mold (punch) heated to 140° C. was pushed from above until a load of 400 kN was applied, and the mold was cooled by air blowing without opening the mold. After the mold was cooled to room temperature, a woody molded article (first molded article) having a small cup shape was taken out.

The first molded article was evaluated for touch, and it was confirmed that the first molded article had a soft feeling and had a good texture.

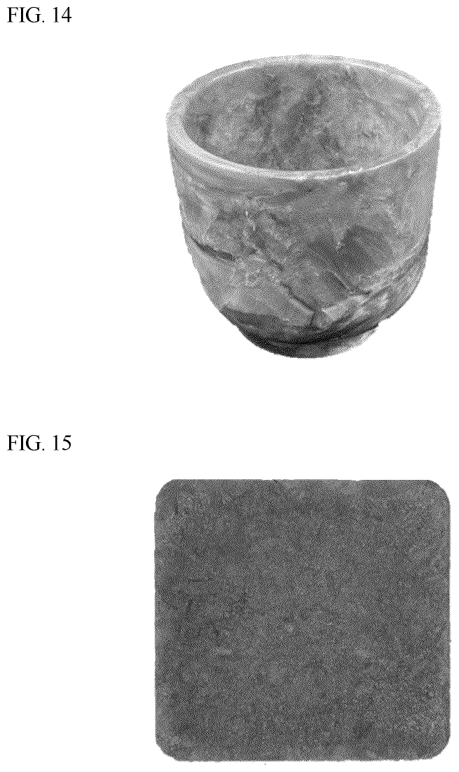

Thereafter, the first molded article was pulverized, and press molding was performed using the pulverized first molded article as a polyurethane-containing woody material under the same conditions as described above, thus preparing a woody molded article (second molded article) having a small cup shape. As a result, as shown in FIG. 14, it has been confirmed that the second molded article has a good texture and remolding can be performed.

### Example 27

The plate-like woody molded article (woody molded article to which a melamine resin had been added) obtained in Example 25 was pulverized. The obtained fibrous pulverized product (particle size: about 0.1 to 1 mm) was filled in a closed mold having a flat plate with a punch area of 52 mm×50 mm set at a temperature of 170° C., and press-molded at a load of 10 ton (about 38 MPa). Thereafter, the mold was cooled to 50° C. or lower, and then the plate-like woody molded article (hereinafter, referred to as “remolded article”) was taken out. As a result, as shown in FIG. 15, the obtained remolded article had a good texture and also had a good shape retention property.

### INDUSTRIAL APPLICABILITY

The polyurethane-containing woody molded article of the present invention is suitable as building materials and building members, furniture and furniture products, vehicle members, home appliance parts, daily necessities and the like having a soft feeling, since a polyurethane formed by reacting a polyethylene glycol and an isocyanate compound derived from a blocked isocyanate compound contained in the polyurethane precursor-containing woody material of the present invention is contained in the cell walls of the woody raw material (raw material wood).

The polyurethane precursor-containing woody material of the present invention is suitable as a raw material for producing the woody molded article.

Furthermore, the polyurethane-containing woody material of the present invention is one in which a polyurethane formed by reacting a polyethylene glycol and an isocyanate compound derived from a blocked isocyanate compound contained in the polyurethane precursor-containing woody material of the present invention is included in the cell wall of the woody raw material (raw material wood), and can be used as a raw material for producing a polyurethane-containing woody molded article regardless of having no predetermined shape.

### REFERENCE SIGNS LIST

1 Wood polymer in cell wall
3 Blocked isocyanate compound
5 Polyethylene glycol

1. A polyurethane precursor-containing woody material comprising a woody raw material impregnated with a blocked isocyanate compound and a polyethylene glycol.

2. The polyurethane precursor-containing woody material according to claim 1,
wherein the polyethylene glycol is represented by a following general formula (1):
HO—(CH₂—CH₂—O)ₙ—H (1)
wherein n is 1 to 12,000.

3. The polyurethane precursor-containing woody material according to claim 1,
wherein the blocked isocyanate compound is a compound which is formed from an isocyanate compound and a blocking agent that protects an isocyanate group contained in the isocyanate compound, and is inactivated by a group derived from the blocking agent, and the blocked isocyanate compound is a compound which leads to the isocyanate compound when the blocked isocyanate compound is heated to dissociate the group derived from the blocking agent.

4. A method for producing the polyurethane precursor-containing woody material according to claim 1, comprising:
contacting the woody raw material with the blocked isocyanate compound and the polyethylene glycol.

5. The method for producing a polyurethane precursor-containing woody material according to claim 4,
wherein the woody raw material is brought into contact with a liquid comprising the blocked isocyanate compound, the polyethylene glycol, and at least one selected from water and a water-soluble organic solvent in the contact process.

6. A method for producing a polyurethane-containing woody material, comprising:
heating the polyurethane precursor-containing woody material according to claim 1 to a temperature at which an isocyanate compound is generated from a blocked isocyanate compound contained in the polyurethane precursor-containing woody material to form a polyurethane from the polyethylene glycol contained in the polyurethane precursor-containing woody material and the generated isocyanate compound.

7. A polyurethane-containing woody material obtained by the producing method according to claim 6.

8. A polyurethane-containing woody material comprising a woody raw material impregnated with a polyurethane represented by a following formula:
R¹—NHCO—O—(CH₂—CH₂—O)ₙ—CONH—R²
wherein R¹ and R² are each CH₂═C(CH₃)COOCH₂CH₂— and n is 1 to 12,000.

9. A method for producing a polyurethane-containing woody molded article, comprising:
heating the polyurethane precursor-containing woody material according to claim 1 to a temperature at which an isocyanate compound is generated from a blocked isocyanate compound contained in the polyurethane precursor-containing woody material to form a polyurethane from the polyethylene glycol contained in the polyurethane precursor-containing woody material and the generated isocyanate compound.

10. The method for producing a polyurethane-containing woody molded article according to claim 9,
wherein pressurization is performed in the heating process.

11. A polyurethane-containing woody molded article obtained by the producing method according to claim 9.

12. A polyurethane-containing woody molded article consisting of an aggregate of the polyurethane-containing woody material comprising a woody raw material impregnated with a polyurethane represented by a following formula:
R¹—NHCO—O—(CH₂—CH₂—O)ₙ—CONH—R²
wherein R¹ and R² are each CH₂═C(CH₃)COOCH₂CH₂— and n is 1 to 12,000.
